(19) United States
(12) Patent Application Publication
(10) Pub. No.: US 2009/0145971 A1
(43) Pub. Date: Jun. 11, 2009

(54) PRINTED WIRELESS RF IDENTIFICATION LABEL STRUCTURE

(76) Inventor: Wen Cheng YIN, Taoyuan County (TW)

Correspondence Address: Wen Cheng Yin, 235 Chung - Ho, Box 8-24, Taipei, TW

(21) Appl. No.: 11/952,150

(22) Filed: Dec. 7, 2007

(51) Int. Cl. G06K 19/06

(52) U.S. Cl. 235/492

(57) ABSTRACT

A printed wireless RF identification label structure, comprises a card body, at least one sensing layer, a chip module, and a jump circuit. The card body is formed by a plurality of stacked. An antenna coil is printed upon the sensing layer and the sensing layer sandwiched between the plurality of stacked layers of the card body, which an antenna coil including two chip pads, a loop inner joint and a loop outer joint. Then the chip module is adhered to the two chip pads of the antenna coil. The jump circuit is disposed between the loop inner joint and the loop outer joint of the antenna coil to form receiving an antenna coil that transmits a data of the chip module, thereby forming a wireless receiving and transmitting structure.

### FIELD OF THE INVENTION

The present invention relates to RFID (Radio Frequency Identify), and particularly to a printed wireless RF identification label structure, wherein an antenna coil is formed by printing conductive material. The present invention can be widely used in such as IC chip cards, SMART cards, magnetic cards, VIP cards, identification cards, traffic cards, etc. Furthermore, the present invention can improve the efficiently of antenna coil to reaction a reader which has a compact volume and a high stability and quality.

### BACKGROUND OF THE INVENTION

Currently, the RFID (radio frequency identify) labels are widely used in many field, such as controlling of credit cards, phone cards, stock management, merchandise control, door control, ID control, baggage control, etc. In the RFID, an RF label with an antenna coil is combined with a chip module. Then the RFID is attached to a non-contact card or a contact card that the data in the chip module will be transmitted wireless to a reader through the antenna coil so as to perform a required work. RFIDs are widely used in identification, tracking, statistics, checking, accounting, stock control, etc. The use of RFID has become a worldwide trend.

The antenna coil is main concern in the design and application. The antenna coil in RFID can deeply affect the normal work of the RFIDs. The RFIDs have been combined with cards, control of merchandises, door control, ID identification, medical applications in the case history control etc.

In the conventional of the RFID, the antenna coil is formed by etching or circuit bonding process, wherein the, of the etching process will cause the environment pollution and the circuit bonding process may result in non-uniform thickness of the antenna coil lead to the yield rate be decreased while packaging the chip module on the substrate.

To improve above mentioned defects, the inventor of the present invention has engaged in the technologies of materials, packaging, tests, etc. In that, the antenna coil can be printed upon a card (such as a paper card, a plastic card or a circuit board). The process has stable quality, a compact volume and a high quality.

### SUMMARY OF THE INVENTION

Accordingly, the primary object of the present invention is to provide a printed wireless RF identification label structure, wherein an antenna coil is formed by printing conductive material. The present invention can be widely used in such as IC chip cards, SMART cards, magnetic cards, VIP cards, identification cards, traffic cards, etc. Furthermore, the present invention has a compact volume and high stability and quality.

To achieve above objects, the present invention provides a printed wireless RF identification label structure which includes a card body, at least one sensing layer, a chip module, and a jump circuit. The card body is formed by a plurality of stacked layers. At least one antenna coil is printed upon the sensing layer. The sensing layer is sandwiched between the plurality of stacked layers of the card body. The antenna coil includes two chip pads, a loop inner joint and a loop outer joint. The chip module is adhered to the two chip pads of the antenna coil. The jump circuit is formed by an insulation layer and a connecting conductive material, which the insulation layer is disposed between the loop inner joint and the loop outer joint and covers a part of the antenna coil. The connecting conductive material is overlapped upon the insulation layer and between the loop inner joint and loop outer joint to form receiving an antenna coil that transmits a data of the chip module, thereby forming a wireless receiving and transmitting structure.

The printed wireless RF identification label structure could further derive to difference structures Moreover, different structures can be derived from the printed wireless RF identification label structure. For example, the at least one sensing layer of the printed wireless RF identification label structure further includes a cavity for embedding the chip module in order to verify the disposition of the chip module.

In addition, in the printed wireless RF identification label structure, a side of the any stacked layer in the plurality of stacked layer of the card body, further includes magnetic tape is taken as a contact type card.

The antenna coil is formed by printing conductive material upon the sensing layer of the card body. The insulation layer of the jump circuit is made by insulation material.

In another example of the present invention, a printed wireless RF identification label structure includes a card body, at least one sensing layer, a chip module, and a conductive circuit, wherein the card body is formed by a plurality of stacked layers. At least one sensing layer is sandwiched between the plurality of stacked layers of the card body and the sensing layer is formed with a plurality of through holes and an antenna coil is printed upon the sensing layer. The antenna coil includes two chip pads, a loop inner joint and a loop outer joint. The plurality of through holes, the loop inner joint and loop outer joint are formed at the same area. The chip module is adhered to the two chip pads of the antenna coil. The conductive circuit material is adhered upon a backside of the sensing layer. Two end points of the conductive material are filled to the through holes of the sensing layer and the through holes are also filled with the conductive material with the loop inner joint and loop outer joint of the antenna coil so as to receiving an antenna coil function, that transmits a data of the chip module, thereby forming a wireless receiving and transmitting structure.

In another example of the present invention could further derive to difference structure. Moreover, different structures can be derived from the printed wireless RF identification label structure. For example, the at least one sensing layer of the printed wireless RF identification label structure further includes a cavity for embedding the chip module in order to verify the disposition of the chip module.

In addition, in the printed wireless RF identification label structure , a side of the any stacked layer in the plurality of stacked layer of the card body, further includes magnetic tape is taken as a contact type card.

The antenna coil is formed by printing conductive material upon the sensing layer of the card body and the conductive circuit is formed by printing conductive material upon the backside of the sensing layer.

In another example of the present invention, a printed wireless RF identification label structure includes a card body, at least one sensing layer, and a chip module. The card body is formed by a plurality of stacked layers. At least one sensing layer is sandwiched between the plurality of stacked layers of the card body. The chip module is adhered to the two distal ends of the antenna coil of the sensing layer and a backside of the chip module has an insulation layer. The chip module is adhered to two distal ends of the antenna coil to form receiving an antenna coil that transmits a data of the chip module, thereby forming a wireless receiving and transmitting structure.

The printed wireless RF identification label structure could further derive to difference structures. Moreover, different structures can be derived from the printed wireless RF identification label structure. For example, a side of the any stacked layer in the plurality of stacked layer of the card body, further includes magnetic tape is taken as a contact type card.

By the way mentioned above, according to the present invention about the primary object, an antenna coil is adhered to the conductive material from the loop inner joint to the loop outer to achieve the jump circuit to form receiving an antenna coil that transmits a data of the chip module, thereby forming a wireless receiving transmitting structure. Another primary object of the present invention using a conductive material is adhered upon a backside of the sensing layer and the two end points of the part of conductive material by the printed process will passed and filled with the through holes. The through holes filled with the conductive material that pass to the loop inner joint and the loop outer joint of the sensing layers of the card body to form receiving an antenna coil that transmits a data of the chip module, thereby forming a wireless and transmitting.

The card body may be one of an IC chip card, a SMART card, a magnetic card, a VIP card, an identification card, a traffic card, etc. The thickness of the card body is between 0.6 mm to 0.9 mm. The electricity of the card body has a working frequency between 0 to 5.8 GHz, an antenna resistance between 0.01 to 150 Ohm (Ω), an inductance between 0.01˜10 μH, a capacitance between 0.01˜10 pF and a quality factor between 1 to 1000, etc.

To the accomplishment of the foregoing and related ends, the invention 25 comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a plane schematic view about the preferred embodiment of the present invention.

FIG. 2 is a plane schematic view showing the structure of the preferred embodiment of the present invention.

FIG. 3 is a plane schematic view showing another structure of the preferred embodiment of the present invention.

FIG. 4 is a plane schematic view of the second embodiment of the present invention.

FIG. 5 is a plane schematic view showing the structure of the second embodiment of the present invention.

FIG. 6 is a plane schematic view showing another structure of the second embodiment of the present invention.

FIG. 7 is a plane schematic view of the third embodiment of the present invention.

FIG. 8 is a plane schematic view showing the structure of the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

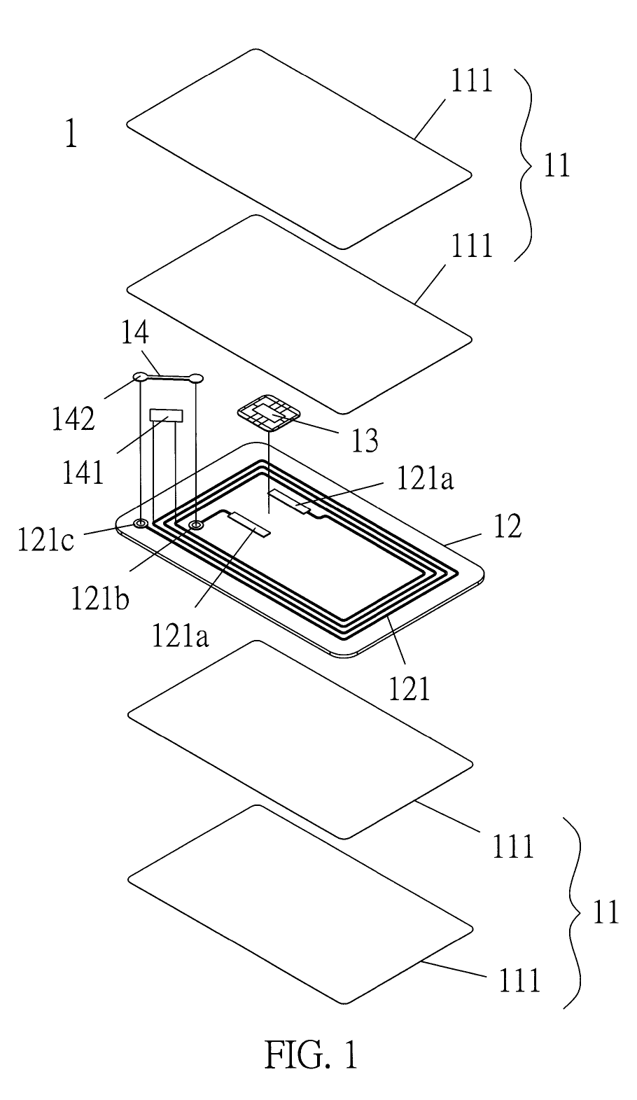

Referring to FIG. 1, a plane view about a preferred embodiment of the present invention is illustrated. The printed wireless RF identification label structure of the present invention includes a card body 11, at least one sensing layer 12 a chip module 13, and a jump circuit 14. The card body 11 is formed by a plurality of stacked layers 111. An antenna coil 121 is printed upon the sensing layer 12. The sensing layer 12 is sandwiched between the pluralities of stacked layers 111 of the card body 11. The antenna coil 121 includes two chip pads 121a, a loop inner joint 121b and a loop outer joint 121c. The chip module 13 is adhered to the two chip pads 121a of the antenna coil 121. The jump circuit 14 is formed by an insulation layer 141 and a connecting conductive circuit 142. The insulation layer 141 is disposed between the loop inner joint 121b and the loop outer joint 121c and covers a part of the antenna coil 121 to prevent said antenna coil short. The connecting conductive material 142 is overlapped upon the insulation layer 141 and between the loop inner joint 121b and loop outer joint 121c so as to form receiving an antenna coil 121 that transmits a data of the chip module 13, thereby forming a wireless receiving and transmitting structure.

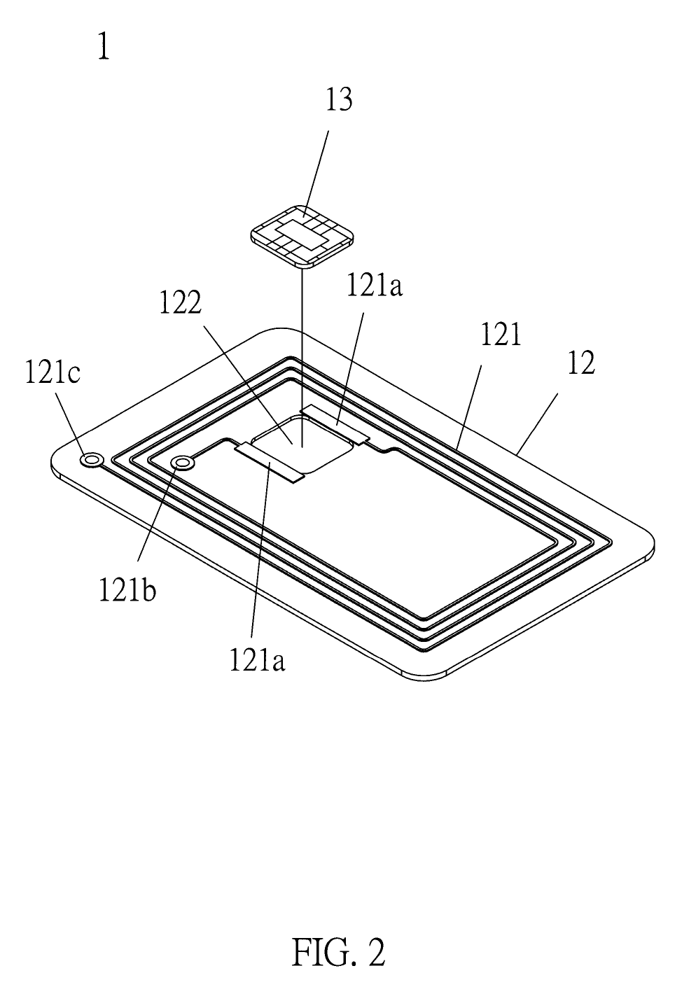

Referring to FIG. 2 with reference to FIG. 1, the plane schematic view about another embodiment of the present invention is illustrated. In FIG. 2, the at least one sensing layer 12 of the printed wireless RF identification label structure further includes a cavity 122 for embedding the chip module 13.

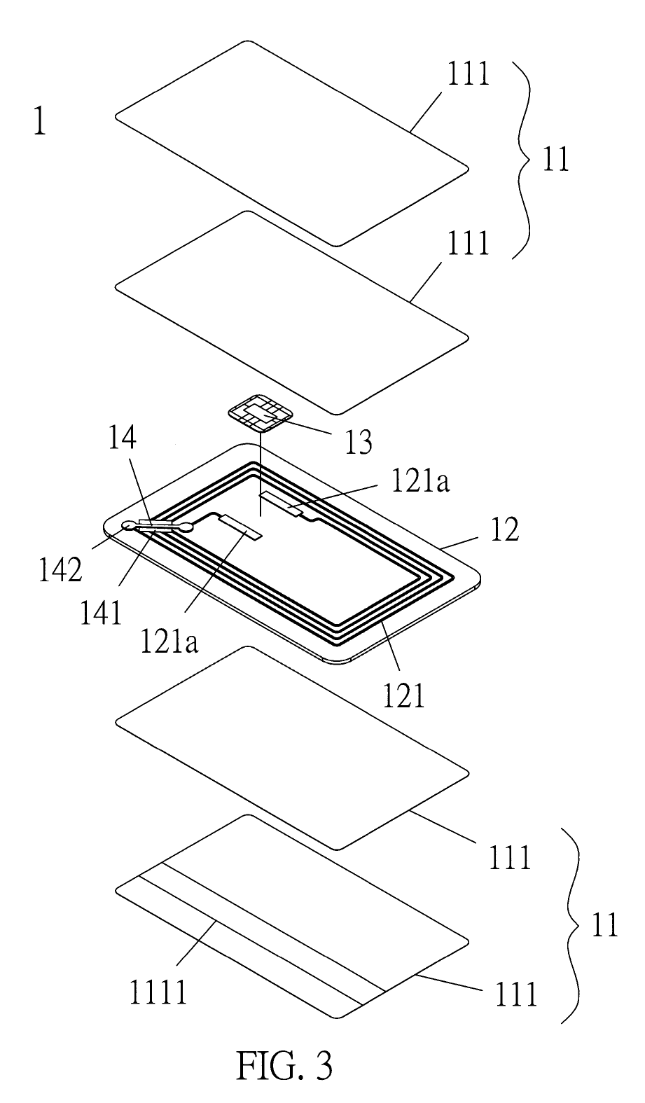

Referring to FIG. 3 with reference to FIG. 1, a further embodiment of the present invention is illustrated. In this embodiment, a side of the any stacked layer 111 in the plurality of stacked layer 111 of the card body 11 of the of the printed wireless RF identification label structure 1 further includes magnetic tape is taken as a contact type card.

In summary, as referring to FIG. 1, when the chip module 13 is connected to the antenna coil 121, a reader (not shown) in the RF (radio frequency) identification system will provide a RF signal to the antenna coil 121 of the card body 11 so as to actuate the antenna coil 121. Thus the data in the chip module 13 will be encoded and transferred through the antenna coil 121. Then the reader (not shown) will receive the signal from the antenna coil 121 and the signal is decoded and the decoded signal is transferred to a rear-end main system for further processing. The main system will determine whether the signal is a permissible one. Then the main system performs the corresponding process and control so as to emit instruction signals to other processing mechanisms. Thus the printed wireless RF identification label structure 1 of the present invention has the function of transmitting, receiving and operation. When the chip module 13 in the printed wireless RF identification label structure 1 is connected to the antenna coil 121, it will cause that the antenna coil 121 and reader communicate to one another through RF transmission.

The antenna coil 121 is formed by printing conductive material upon the sensing layer 12 of the card body 11. The insulation layer 141 of the jump circuit 14 is made by insulation material. The card body 11 may be one of an IC chip card, a SMART card, a magnetic card, a VIP card, an identification card, a traffic card, etc. The thickness of the card body 11 is between 0.6 mm to 0.9 mm. The electrical properties of the card body 11 has a working frequency between 0 to 5.8 GHz, an antenna resistance between 0.01 to 150 Ohm (i), an inductance between 0.01˜10 μH, a capacitance between 0.01˜10 pF and a quality factor between 1 to 1000, etc.

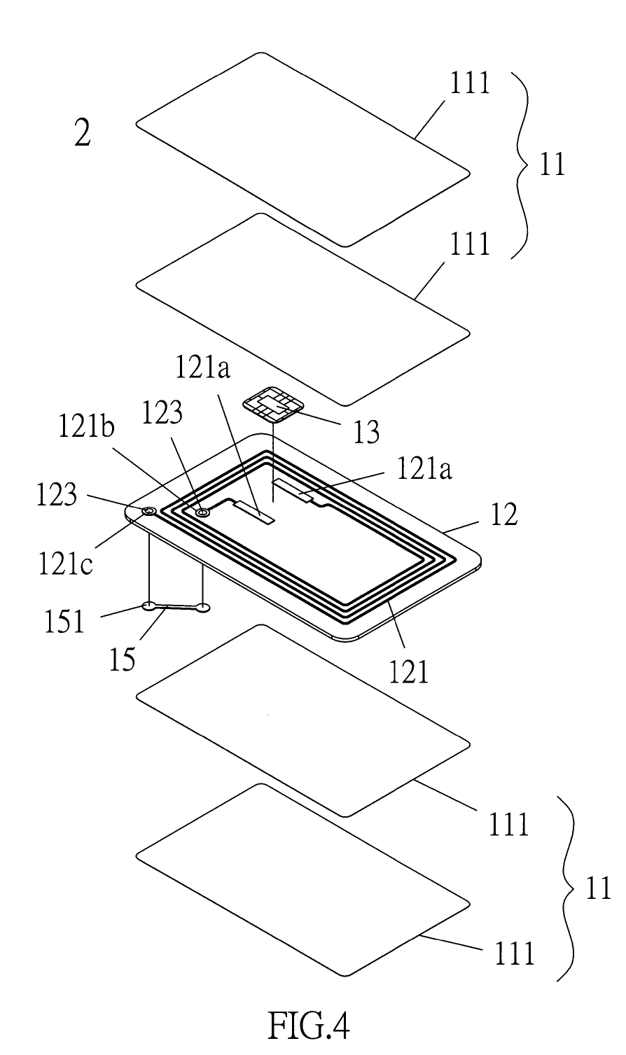

With referring to FIG. 4, a plane schematic view about another embodiment of the present invention is illustrated. In this embodiment, a printed wireless RF identification label structure 2 according to the present invention is illustrated. The printed wireless RF identification label structure 2 includes a card body 11, at least one sensing layer 12, a chip module 13, and a conductive circuit material 15. The card body 11 is formed by a plurality of stacked layers 111. The sensing layer 12 is sandwiched between the pluralities of stacked layers 111 of the card body 11. The sensing layer 12 is formed with the plurality of through holes 123 and an antenna coil 121 is printed upon the sensing layer 12. The antenna coil 121 includes two chip pads 121a, a loop inner joint 121b and a loop outer joint 121c. The plurality of through holes 123, the loop inner joint 121b and loop outer joint 121c are formed at the same area. The chip module 13 is adhered to the two chip pads 121a of the antenna coil 121. The conductive circuit material 15 is adhered upon a backside of the sensing layer 12. Two end points 151 of the conductive circuit material 15 are filled to the through holes 123 of the sensing layer 12 and the through holes 123 are also filled with conductive material 15, with the loop inner joint 121b and loop outer joint 121c of the antenna coil 121 so as to receiving an antenna coil 121 function, that transmits a data of the chip module 13, thereby forming a wireless receiving and transmitting structure.

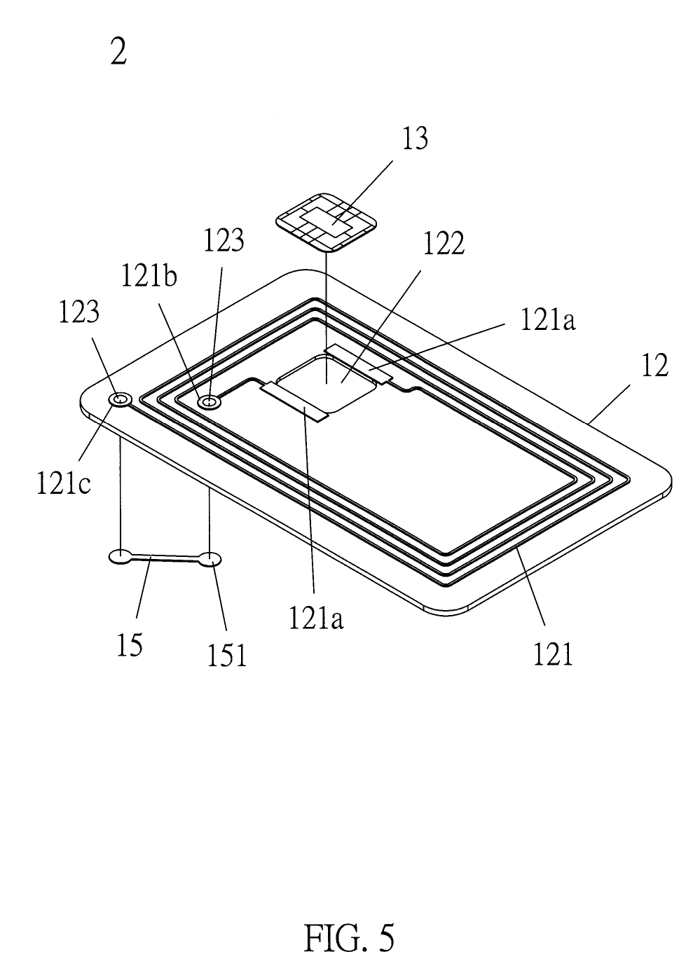

Referring to FIG. 5 with reference to FIG. 4, the plane schematic view about another embodiment of the present invention is illustrated in FIG. 5, the at least one sensing layer 12 of the printed wireless RF identification label structure 2 further includes a cavity 122 for embedding the chip module 13.

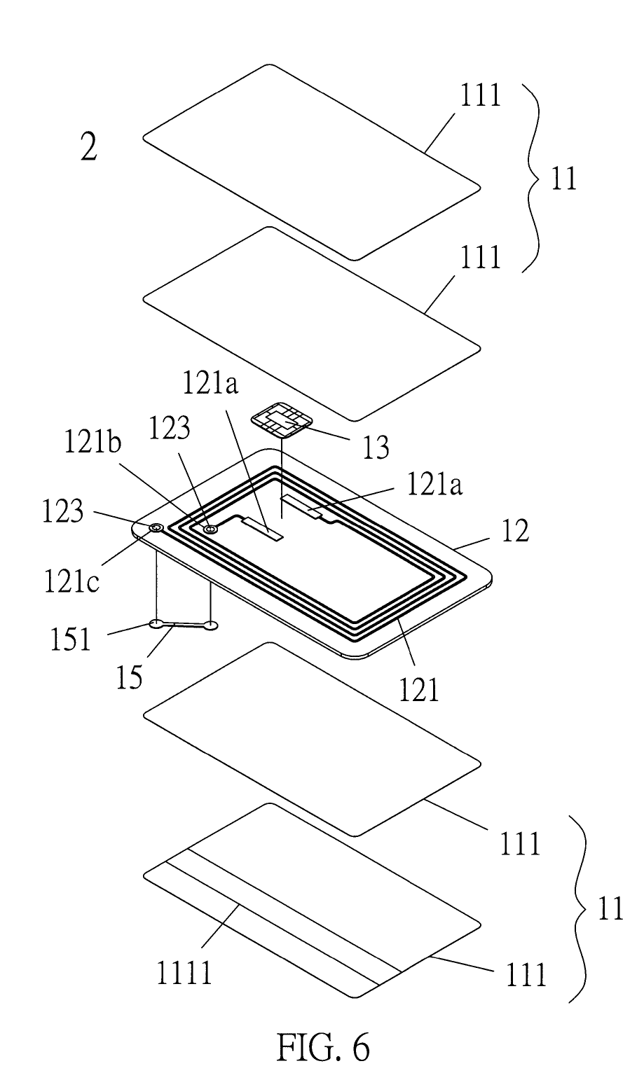

Referring to FIG. 6 with reference to FIG. 4, the plane schematic view about another embodiment of the present invention is illustrated. In this embodiment, a side of the any stacked layer 111 in the plurality of stacked layer 111 of the card body 11 of the of the printed wireless RF identification label structure 2 further includes magnetic tape is taken as a contact type card.

In summary, as referring to FIG. 4, when the chip module 13 is connected to the antenna coil 121, a reader (not shown) in the RF (radio frequency) identification system will provide a RF signal to the antenna coil 121 of the card body 11 so as to actuate the antenna coil 121. Thus the data in the chip module 13 will be encoded and transferred through the antenna coil 121. Then the reader (not shown) will receive the signal from the antenna coil 121 and the signal is decoded and the decoded signal is transferred to a rear-end main system for further processing. Then the main system will determine whether the signal is a permissible one. The main system performs the corresponding process and control so as to send instruction signals to other processing mechanisms. Thus the printed wireless RF identification label structure 2 of the present invention has the function of transmitting, receiving and operation. When the chip module 13 in the printed wireless RF identification label structure 2 is connected to the antenna coil 121, it will cause that the antenna coil 121 and reader are communicated to one another through RF transmission.

The antenna coil 121 is formed by printing conductive material upon the sensing layer 12 of the card body 11 and the conductive circuit 15 is formed by printing conductive material upon the backside of the sensing layer 12. The card body 11 may be one of an IC chip card, a SMART card, a magnetic card, a VIP card, an identification card, a traffic card, etc. The thickness of the card body 11 is between 0.6 mm to 0.9 mm. The electrical properties of the card body 11 has a working frequency between 0 to 5.8 GHz, an antenna resistance between 0.01 to 150 Ohm (Ω), an inductance between 0.01˜10 μH, a capacitance between 0.01˜10 pF and a quality factor between 1 to 1000, etc.

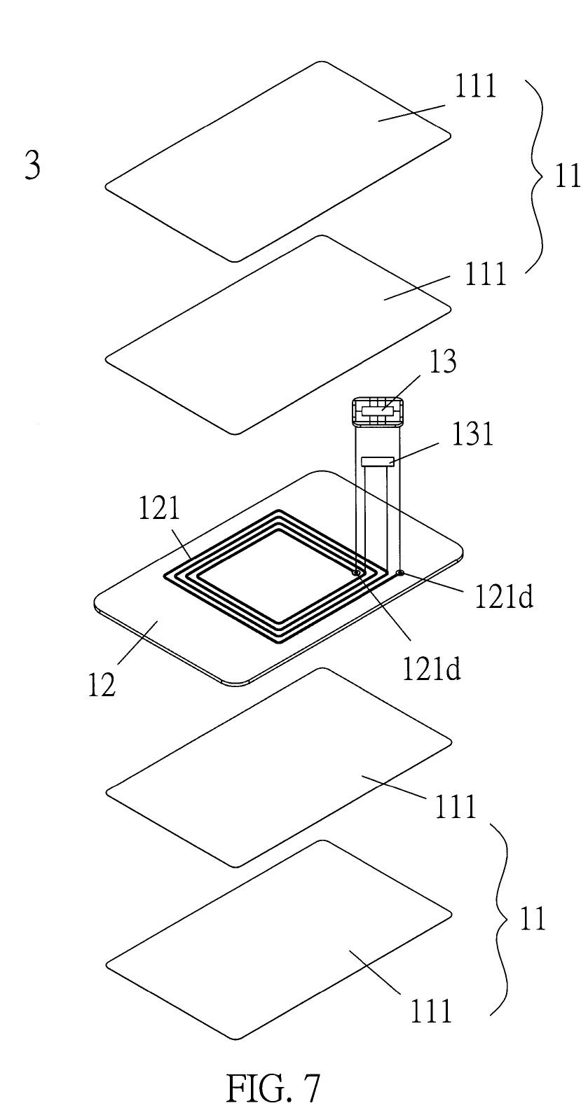

With referring to FIG. 7 a plane schematic view about another embodiment of the present invention is illustrated. In this embodiment, a printed wireless RF identification label structure 3 according to the present invention is illustrated. The printed wireless RF identification label structure 3 includes a card body 11, at least one sensing layer 12, and a chip module 13. The card body 11 is formed by a plurality of stacked layers 111. The sensing layer 12 is sandwiched between the plurality of stacked layers 111 of the card body 11. The chip module 13 is adhered to the two distal ends 121d of the antenna coil 121 of the sensing layer 12 and a backside of the chip module 13 has an insulation layer. The two distal ends 121d of the antenna coil 121 are filled with conductive materials so as to receiving an antenna coil 121 function, that transmits a data of the chip module 13, thereby forming a wireless receiving and transmitting structure.

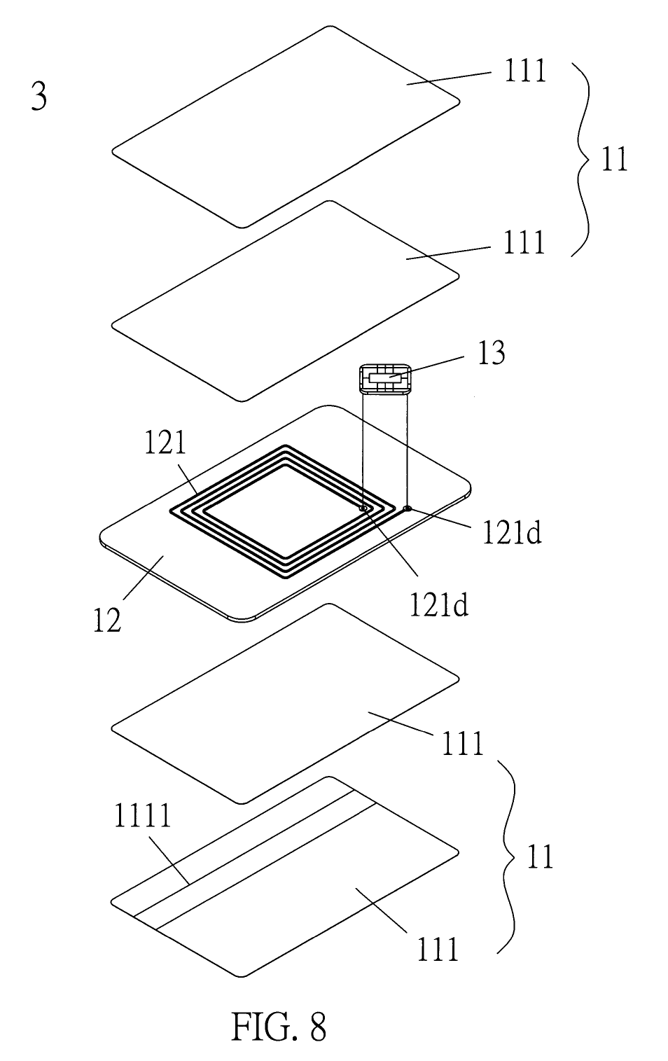

Referring to FIG. 8 with reference to FIG. 7, the plane schematic view about another embodiment of the present invention is illustrated. In this embodiment, a side of the any stacked layer 111 in the plurality of stacked layer 111 of the card body 11 of the of the printed wireless RF identification label structure 3 further includes magnetic tape is taken as a contact type card.

In summary, as referring to FIG. 7, when the chip module 13 is connected to the antenna coil 121, a reader (not shown) in the RF (radio frequency) identification system will provide steady RF signals to the antenna coil 121 of the card body 11 so as to actuate the antenna coil 121. Thus the data in the chip module 13 will be encoded and transferred through the antenna coil 121. Then the reader will receive the signal from the antenna coil 121 and the signal is decoded and the decoded signal is transferred to a rear end main system for further processing. The main system will determine whether the signal is a permissible one. Then the main system performs the corresponding process and control so as to emit instruction signals to other processing mechanisms. Thus the printed wireless RF identification label structure 3 of the present invention has the function of transmitting, receiving and operation. When the chip module 13 in the printed wireless RF identification label structure 3 is connected to the antenna coil 121, it will cause that the antenna coil 121 and reader are communicated to one another through RF transmission.

The antenna coil 121 is formed by printing conductive material upon the sensing layer 12 of the card body 11. The card body 11 may be one of an IC chip card, a SMART card, a magnetic card, a VIP card, an identification card, a traffic card, etc. The thickness of the card body 11 is between 0.6 mm to 0.9 mm. The electrical properties of the card body 11 has a working frequency between 0 to 5.8 GHz, an antenna resistance between 0.01 to 150 Ohm (Ω), an inductance between 0.01˜10 μH, a capacitance between 0.01˜10 pF and a quality factor between 1 to 1000, etc.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A printed wireless RF identification label structure, comprising:
a card body formed by a plurality of slacked layers;
at least one sensing layer; an antenna coil is printed upon the sensing layer and the sensing layer sandwiched between the plurality of stacked layers of the card body, which the antenna coil including two chip pads, a loop inner joint and a loop outer joint;
a chip module adhered to the two chip pads of the antenna coil; and
a jump circuit formed by an insulation layer and a connecting conductive material;
wherein, the insulation layer is disposed between the loop inner joint and the loop outer joint and covered part of the antenna coil; which the connecting conductive material overlapped upon the insulation layer and between the loop inner joint and loop outer joint to form receiving an antenna coil that transmits a data of the chip modules thereby forming a wireless receiving and transmitting structure.

2. The printed wireless RF identification label structure as claimed in claim 1, wherein the at least one sensing layer further includes a cavity for embedding the chip module.

3. The printed wireless RF identification label structure as claimed in claim 1, wherein a side of the any stacked layer in the plurality of stacked layer of the card body further includes magnetic tape.

4. The printed wireless RF identification label structure as claimed in claim 1, wherein the card body is one of an IC chip card, a SMART card, a magnetic card, a VIP card, an identification card, and a traffic card.

5. The printed wireless RF identification label structure as claimed in claim 1, wherein the thickness of the card body is between 0.6 mm to 0.9 mm.

6. The printed wireless RF identification label structure as claimed in claim 1, wherein the antenna coil is formed by printing conductive material upon the sensing layer of the card body; and wherein the insulation layer of the jump circuit is made by insulation material.

7. (canceled)

8. The printed wireless RF identification label structure as claimed in claim 1, wherein the electricity of the printed wireless RF identification label structure includes electrical properties: working frequency, antenna resistance, quality factor, inductance, and capacitance.

9. A printed wireless RF identification label structure, comprising:
a card body formed by a plurality of stacked layers;
at least one sensing layer; an antenna coil is printed upon the sensing layer and the sensing layer sandwiched between the plurality of stacked layers of the card body, which the antenna coil including two chip pads, a loop inner joint and a loop outer joint;
a chip module adhered to the two chip pad of the antenna coil; and
a conductive material adhered upon a backside of the sensing layer;
wherein two end points of the conductive material is filled to the plurality of through holes of the sensing layer and filled to the loop inner joint and loop outer joint of the antenna coil to form receiving an antenna coil that transmits a data of the chip module, thereby to forming a wireless receiving and transmitting structure.

10. The printed wireless RF identification label structure as claimed in claim 9, wherein the at least one sensing layer further includes a cavity for embedding the chip module; and wherein a side of the any stacked in the polarity of stacked layer of the card body further includes magnetic tape.

11. (canceled)

12. The printed wireless RF identification label structure as claimed in claim 9, wherein the thickness of the card body is between 0.6 mm to 0.9 mm.

13. The printed wireless RF identification label structure as claimed in claim 9, wherein tile card body is one of an IC chip card, a SMART card, a magnetic card, a VIP card, an identification card, and a traffic card.

14. The printed wireless RF identification label structure as claimed in claim 9, wherein the antenna coil is formed by printing conductive material upon the sensing layer of the card body.

15. The printed wireless RF identification label structure as claimed in claim 9, wherein the conductive material is formed by printing conductive material upon the backside of the sensing layer.

16. The printed wireless RF identification label structure as claimed in claim 9, wherein the electricity of the printed wireless RF identification label structure includes electrical properties working frequency, antenna resistance, quality factor, inductance, and capacitance.

17. The printed wireless RF identification label structure as claimed in claim 9, wherein the conductor material is a liquid conductor.

18. A printed wireless RF identification label structure, comprising:
a card body formed by a plurality of stacked layers;
at least one sensing layer; an antenna coil is printed upon the sensing layer and the sensing layer sandwiched between the plurality of stacked layers of the card body; and
a chip module adhered to the two distal ends of the antenna coil of the sensing layer, a backside of the chip module having an insulation layer;
wherein the chip module is adhered to two distal ends of the antenna coil to form receiving all antenna coil that transmits a data of the chip module, thereby forming a wireless receiving and transmitting structure.

19. The printed wireless RF identification label structure as claimed in claim 18, wherein a side of the any stacked layer in the plurality of stacked layer of the card body further includes magnetic tape.

20. The printed wireless RF identification label structure as claimed in claim 18, wherein the thickness of the card body is between 0.6 mm to 0.9 mm.

21. The printed wireless RF identification label structure as claimed in claim 18, wherein the card body is one of an IC chip card, a SMART card, a magnetic card, a VIP card, an identification card, and a traffic card.

22. The printed wireless RF identification label structure as claimed in claim 18, wherein the antenna coil is formed by printing conductive material upon the sensing layer of the card body; and wherein the electricity of the printed wireless RF identification label structure includes electrical properties working frequency antenna resistance, quality factor, inductance, and capacitance.

23. (canceled)
